(19) United States
(12) Patent Application Publication
(10) Pub. No.: US 2017/0289841 A1
(43) Pub. Date: Oct. 5, 2017

(54) METHOD AND APPARATUS FOR IMPROVING COMMUNICATION EFFICIENCY

(71) Applicant: Nokia Solutions and Networks Oy, Espoo (FI)

(72) Inventor: Henri Markus KOSKINEN, Espoo (FI)

(21) Appl. No.: 15/510,784

(22) PCT Filed: Sep. 25, 2014
(86) PCT No.: PCT/EP2014/070538

§ 371 Date: Mar. 13, 2017

(51) Int. Cl. H04W 28/02; H04W 28/06; H04L 12/26; H04L 12/801

(52) U.S. Cl. CPC H04W 28/0284; H04L 47/34; H04W 28/06; H04L 43/062

(57) ABSTRACT

There is provided a method, comprising: detecting that an overflow counter value applied by the user device in reception of data transmission from a network node is different than the overflow counter value applied by the network node to the data transmission; and transmitting a reception-status report to the network node to inform the network node about the detection.

### FIELD OF THE INVENTION

The invention relates generally to wireless communication networks.

### BACKGROUND

It is important to keep track of the order of transmitted data packets by a transmitter and a receiver. Some part of this information may be synchronously maintained by the communicating parties, instead of transmitting the information repeatedly over the air interface. In case the receiver or transmitter is de-synchronized with respect to this information, problems may occur.

### BRIEF DESCRIPTION OF THE INVENTION

The invention is defined by the independent claims.

Some embodiments of the invention are defined in the dependent claims.

### LIST OF THE DRAWINGS

In the following, the invention will be described in greater detail with reference to the embodiments and the accompanying drawings, in which

FIG. 1 presents a network node and a user equipment according to some embodiment;

FIG. 2A shows how a sequence number may be included in a transmitted data packet, according to an embodiment;

FIG. 2B shows how a hyper frame number may be used according to an embodiment;

FIGS. 3 and 4 illustrate methods according to some embodiments

FIG. 5 depicts a signalling flow diagram according to an embodiment;

FIG. 6 illustrates an example reception-status report according to an embodiment;

FIG. 7A and 7B shows an embodiment regarding a detection of a de-synchronization of a overflow counter value at the network node on the basis of a received status report; and

FIGS. 8 and 9 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G sys-tem. However, for the sake of simplicity let us use the LTE/LTE-A in the description.

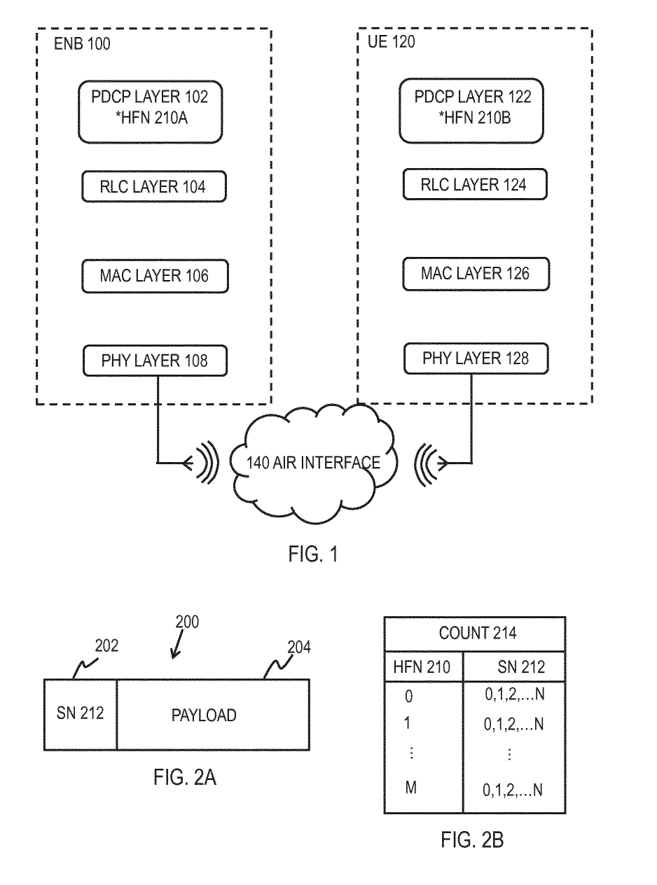

FIG. 1 depicts a part of an LTE protocol stack of an evolved node B (eNB) and a user equipment (UE) 120. The protocol stacks comprise, e.g., a packet data convergence protocol (PDCP) layers 102, 122. The PDCP layer 102, 122 may be responsible of tasks, such as header compression and decompression of internet protocol (IP) data flows using the robust header compression (ROHC) protocol, transfer of data (user plane or control plane), ciphering and deciphering of user plane data and control plane data, integrity protection and verification, maintenance of PDCP sequence numbers (SN), sequential delivery of upper layer protocol data units (PDUs) at re-establishment of lower layers, and/or duplicate elimination of lower layer service data units (SDUs) at re-establishment of lower layers (at least for radio bearers mapped on acknowledged (AM) mode of the radio link control (RLC) 104, 124), for example. The layers above the PDCP layers 102, 122 are not depicted in FIG. 1 for simplicity.

The RLC layers 104, 124 may be responsible of transferring of upper layer PDUs, error correction through, e.g., automatic repeat request (ARQ), concatenation, segmentation and reassembly of RLC SDUs, and/or reordering of RLC data PDUs, for example. The RLC layer may have different operations modes, including the AM mode and an unacknowledged mode (UM). The RLC AM mode may comprise segmentation and reassembly of RLC SDUs into RLC PDUs (transmission) and assembly of RLC PDUs into RLC SDUs (reception), adding/removing of RLC headers to/from the payload and use of sequence numbers for reliable sequence delivery service. In the AM mode, a copy of the transmit buffer may be maintained so that retransmissions are possible, if requested. The UM mode may be less reliable as no acknowledgements are expected by the transmitter from the receiver. Thus, there may not be any transmit buffer copy maintained.

The medium access control (MAC) layers 106, 126 may perform tasks such as error correction, mapping between different types of channels and priority handling. The physical (PHY) layers 108, 128 may then transmit/receive the data to/from the air interface 140.

As said, the order of transmitted data packets may need to be known by the communicating parties, e.g. the eNB 100 and the UE 120. One possible way of indicating the packet order is to associate sequence numbers (SN) with the transmitted frames/packets. In an embodiment, it is the PDCP layer 104, 124 that performs the sequence numbering of the packets. These SNs may be included in headers of the transmitted packets, for example, or the SN may be extractable implicitly from the packets. In an embodiment, as shown in FIG. 2A, an SN field 202 of the transmitted packet 200 (e.g. PDCP PDU) indicates the sequence number 212 of the corresponding PDCP PDU 200 given for transmittal to the lower RLC layer 106, 126. The payload part 204 (e.g. the PDCP SDU) may carry the actual data, be it either control data or user data. The SN field 202 may have a varying length. In one embodiment it is 5, 7 or 12 bits in length. It should be noted that FIG. 2A is a simplified frame structure showing only the SN field 202 and the payload field 204, other possible field(s) are omitted for the sake of simplicity.

However, the limited size SN 212 may run into its end in which case the same SN 212 may be given to two (or more) different packets. At least partly for this reason, an overflow counter mechanism may be used in the eNB 100 and in the UE 120 in order to limit the actual number of sequence number bits that is needed to be sent over the radio interface 140. An example overflow mechanism is hyper frame number (HFN) 210 of FIG. 2B. When the PDCP SN 212 has reached its maximum value N (which in turn depends on number of bits used for the PDCP SN (e.g. 5, 7 or 12 bits)), the PDCP SN 212 may be restarted from zero (0) and the HFN 210 may be increased by one.

The HFN 210 may be initialised to a common value in the UE 120 and in the eNB 100 at certain events, after which the HFN 210 is incremented at every SN cycle. The initialization may be performed at radio-bearer setup or re-establishment, for example.

In an embodiment a parameter 214 generated on the basis of the HFN 210 and the SN 212 may be used at least for security purposes, such as integrity protection/verification and ciphering/deciphering. Let us, for the sake of simplicity, call this parameter 214 a COUNT. In an embodiment, the COUNT 214 for a given packet may have a length of 32 bits and consist of the current HFN 210 and of the current SN 212 for the packet in question. In an embodiment, the SN 212 is comprised in the least significant bits, LSB, (e.g. 5, 7, or 12 LSBs) of the COUNT 214 and the rest of the bits represent the HFN 210.

In order to avoid overhead, the HFN 210 comprising a plurality of bits, such as 20, 25, or 27 (i.e. 32 bits minus 5, 7, or 12 bits), may not be transmitted in the air interface 140 along with the sent packets but synchronously maintained at the communicating parties 100, 120, as shown in FIG. 1 with reference numerals 210A and 210B. Therefore, the knowledge of the HFN 210 needs to be the same and synchronized between the UE 120 and the eNB 100. The synchronization may be take place at certain events, such as at radio-bearer setup or re-establishment, for example.

Nevertheless, there are cases where a de-synchronization of the HFN 210 (HFN de-sync) may take place. In such situations, it may be important that the network becomes aware of the de-sync problem. In uplink (UL), this may take place by the eNB 100 detecting the de-sync problem from the uplink packet itself, e.g. by detecting consecutive problems during deciphering at the eNB 100. However, in case the de-sync occurs in downlink (DL) (DL HFN de-sync), the UE 120 may need to somehow inform the eNB 100 of the detected DL HFN de-sync problem in order to support network-based re-synchronization solutions in which the eNB 100 may then trigger re-synchronization/re-initialization of the HFN 210 between the UE 120 and the eNB 100. The resulting re-synchronization may take place by network initiation via e.g. a handover, RRC connection re-establishment, or by any other way to re-synchronize the HFN 210. The problem at least partially addressed is thus how to inform the eNB 100 about the DL HFN de-sync in an efficient manner.

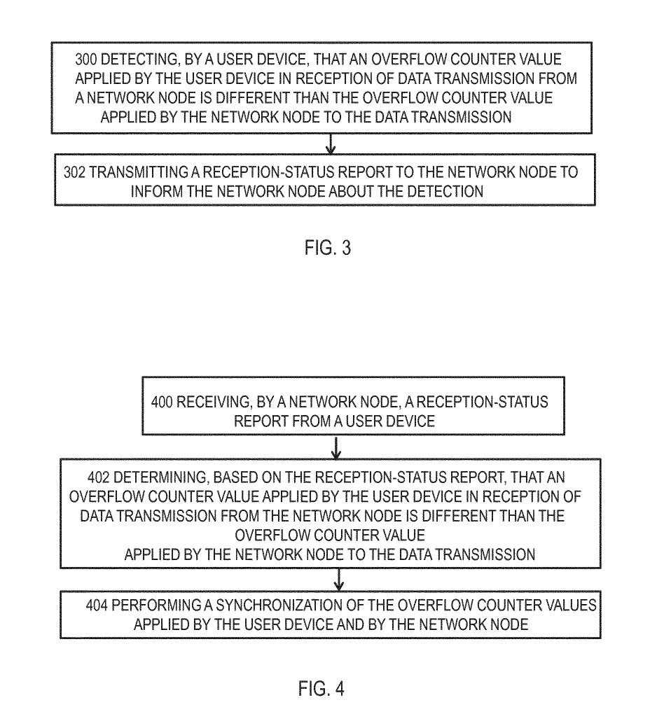

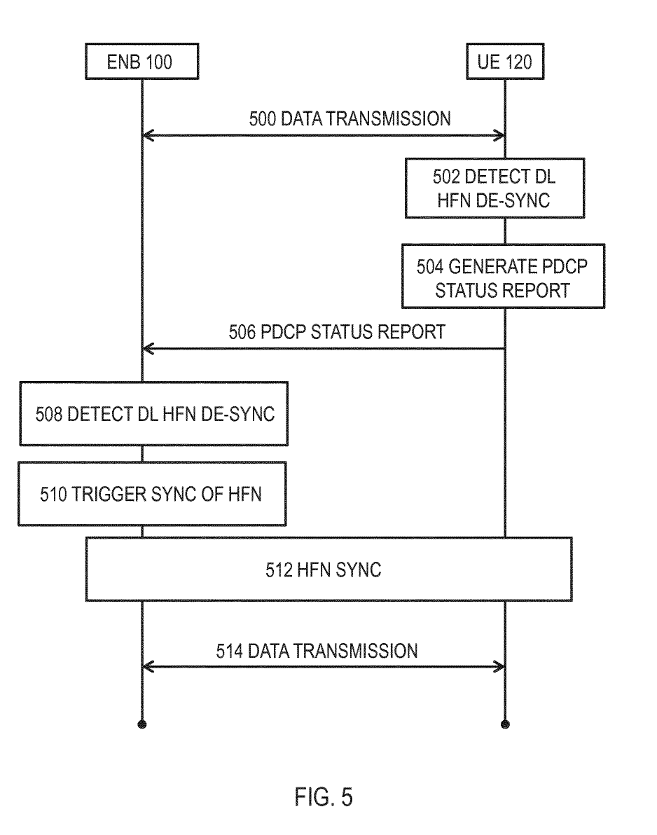

FIG. 3 depicts a method which may be performed by a radio device, such as the UE 120. FIG. 4 depicts a method which may be performed by a network node, such as the eNB 100. FIG. 5 shows a signalling flow diagram between the UE 120 and the eNB 100. The other accompanying Figures may provide further embodiments by describing the method of FIGS. 3 to 5 in details.

Let us assume that in step 500 of FIG. 5 the UE 120 and the eNB 100 perform data transferring. However, the UE 120 may, in steps 300 and 502, detect that the HFN 210B applied by the UE 120 in reception of data from the eNB 100 is different than the HFN 210A applied by the eNB 100. The detection may be based on incapability to decipher the received PDCP SDUs correctly by using the COUNT parameter, which depends on the value of the HFN 210B, for example. With a non-synchronized HFN 210B, the COUNT parameter at the UE 120 is different than the COUNT parameter at the eNB 100 used for ciphering the data. Therefore, the deciphering may not be successfully performed by the UE 120 and the data after the deciphering may be unusable. In one other embodiment, a Checksum-field in the header of the received packet (i.e. PDCP SDU) may be used to detect the HFN de-sync.

As said, the HFN 210A/B may be incremented each time a set of packets/data has been transmitted from the eNB 100 to the UE 120. The maximum number of packets in the set may depend on the amount of bits reserved for the SN 212. However, the changed HFN 210A/B may not signalled between the UE 120 and the eNB 100. Instead, these entities 100, 120 may need to synchronously keep track of the current HFN 210A/B at their own ends. However, according to step 300, the UE 120 may have encountered and detected the DL de-synchronization of the HFN 210A/B.

Although the description uses the term “hyper frame number”, the HFN may be replaced with any overflow counter value which depicts a high level count for the packet/data sets and which is not regularly signalled between the eNB 100 and the UE 120. It may be noted that an indication of the SN 212 may be transmitted along with each packet regularly, but not the overflow counter value 210. The overflow counter value represents the part/portion of the packet counter that is not indicated within packets. The overflow counter value information may be exchanged only upon re-synchronization of the overflow counter value 210 in order to initialize the overflow counter values 210A and 210B to the same value, after which they are incremented according to pre-set rules (e.g. after a predetermined amount of data units has been transmitted/received). For the sake of simplicity, however, the following description will use the term HFN 210A, 210B instead of the term overflow counter value.

In step 504, the UE 120 may then in response to the detection of steps 300 and 502, generate a predetermined reception-status report. The generated reception-status report may be any of the existing types of reception-status reports available, i.e. a default/conventional reception-status report. In the following, simply “status report” is used to mean the reception-status report, for the sake of clarity.

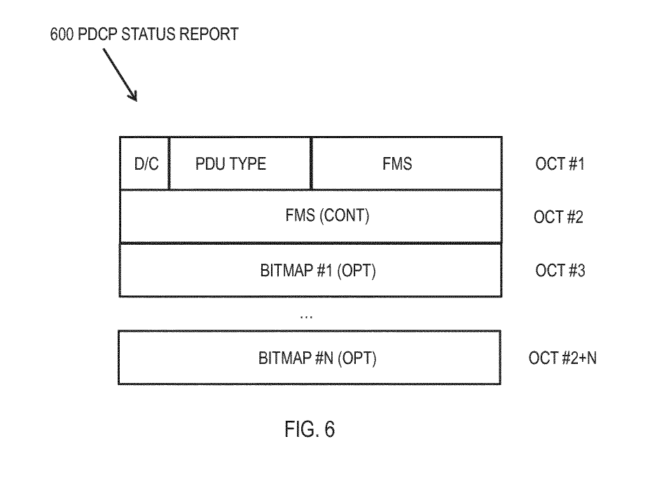

However, for the sake of simplicity, it is assumed in the description that the status report is a PDCP status report. The PDCP status report may be compiled by the PDCP layer 122 of the UE 120 and transmitted to the eNB 100 in uplink. An example PDCP status report 600 is depicted in FIG. 6A. The depicted example PDCP status report 600 may comprise fields, such as a field “D/C” (1 bit) wherein a bit 0 denotes a control PDU and a bit 1 denotes a data PDU (or vice versa), a field “PDU type” (3 bits) indicating the type of the PDU (a value 0 may denote for the status report, for example), a field “FMS” for indicating the PDCP SN of the first missing PDCP SDU, and a “bitmap”-field having a varying length. The most significant bit (MSB) of the first octet of the “bitmap”-field may indicate whether or not the PDCP SDU with the SN (FMS+1) has been received and decompressed correctly. The least significant bit (LSB) of the first octet of the “bitmap”-field may indicate whether or not the PDCP

SDU with the SN (FMS+8) has been received and decompressed correctly. There may be many octets in the “bitmap”-field, as the case may be.

In steps 302 and 506, the UE 120 may then transmit the PDCP status report 600 to the eNB 100 to inform the eNB 100 about the detection of steps 300, 502. The eNB 100 may receive the PDCP status report in step 400.

In steps 402, 508, the eNB 100 may determine, based on the received status report, such as the PDCP status report 600, that the HFN 210B applied by the UE 120 in reception of data transmission from the eNB 100 is different than the HFN 210A applied by the eNB 100 to the data transmission. Thus, the eNB 100 may in this step be informed of the DL HFN de-synchronization. For example, the eNB 100 may be configured to consider the reception of the status report of a predetermined type, such as the PDCP status report 600, as an indication of the DL HFN de-sync problem at the UEs 120 end. In an embodiment, the predetermined type of the status report may be determined by the layer which is responsible for compiling the status report. Thus, only a status report which is generated by the PDCP layer 102, for example, is understood as an indication of a wrong HFN 210B.

In this manner the UE 120 may easily and efficiently inform the detection of the DL HFN de-sync to the eNB 100. When considering some other options for informing the eNB 100 about the de-synch problem, the UE 120 could, e.g., transmit uplink data to the eNB 100, wherein the data would be ciphered with an intentionally wrong HFN value (i.e. with a wrong COUNT value). The eNB 100 would not be able to decipher the uplink data correctly and, thus, detect that a HFN has lost synchronization. However, this would simultaneously cause loss of the UL data and result in lack of efficiency and resources. Therefore, the proposed manner of indicating the DL HFN de-sync to the eNB 100 provides a more efficient and resource optimizing solution.

Further, the proposed manner is not dependent on the uplink HFN sync/de-sync status. That is, the HFN 210A at the eNB 100 end may or may not be correct but the UE 120 may, regardless of this, indicate the DL HFN de-sync problem to the eNB 100 in order to enable the network to determine the consecutive actions. Therefore, the DL HFN de-sync reporting from the UE 120 to the eNB 100 may be performed independently and does not directly cause any UL HFN de-sync events (such as the use of intentionally wrong HFN in the uplink data transmission).

As a result, the eNB 100 may in steps 404 and 510 decide to perform a re-synchronization of the HFNs 210A, 210B applied by the eNB 100 and the UE 120, respectively. The eNB 100 may for example, trigger a re-establishment of the RRC connection of the UE 120 or force a handover of the UE 120, in order to trigger/force network-triggered re-initialization (i.e. re-synchronization) of the HFNs 210A, 210B to a common value. The manner in which the re-synchronization is actually caused by the network node 100 is an implementation specific issue and not described further in the description.

In one embodiment, the UE 120 may indicate, in the status report, a desired way for the eNB 100 to perform the network-triggered re-synchronization of the overflow counter value. For example, predetermined sequence of bits in the bitmap field or in some other field of the status report may be understood by the eNB 100 as a request from the UE 120 to handle the HFN re-synchronization in a specific manner, such as via a handover or via a RRC connection re-establishment. As one example, setting all bits in the last octet in the bitmap to, e.g., ‘0’ may be given a predetermined meaning. In one embodiment, this new meaning may be an indication of the detected DL HFN de-sync, In one embodiment, that sequence of bits may indicate the desired way of performing the HFN re-sync. It may be then left up to the eNB 100 to decide whether the request is followed or not.

Thus, the proposed manner allows a network-based solution for fixing the de-sync problem also for the DL de-synch. As an alternative manner one may consider an UE-based solution for the HFN re-synchronization, e.g. an UE triggered RRC connection re-establishment after detecting the DL HFN de-sync. However, this may introduce relatively long interruption time. Further, it is generally better to leave the connection management to the eNB 100.

In step 512, the eNB 100 and the UE 120 may perform/participate in the network-triggered synchronization of the HFN 210A, 210B. After the re-synchronization (re-initialization) of the HFN 210A, 210B to a common value, the data communication may continue or new data may be communicated successfully between the eNB 100 and the UE 120 in step 514.

Let us then look further on how the eNB 100 detects the DL HFN de-sync problem based on the received status report, such as the PDCP status report 600. In one embodiment, the status report is generated by the UE 120 despite not being configured to send such status report due to other events. In the case where the UE 120 has been configured to send such status report also at other events, a re-establishment has not triggered the PDCP status report generation/transmission. The sole trigger to send the PDCP status report 600 at this point may be the detection of the DL HFN de-sync in step 300. The eNB 100, receiving such a reception-status report of a predetermined type (such as the PDCP status report 600) in the absence of any other event calling for receiving the reception-status report, may in steps 402 and 508, infer that a DL HFN de-sync has taken place, i.e. that the UE 120 is applying a HFN 210B value different than the HFN 210A applied by the eNB 100.

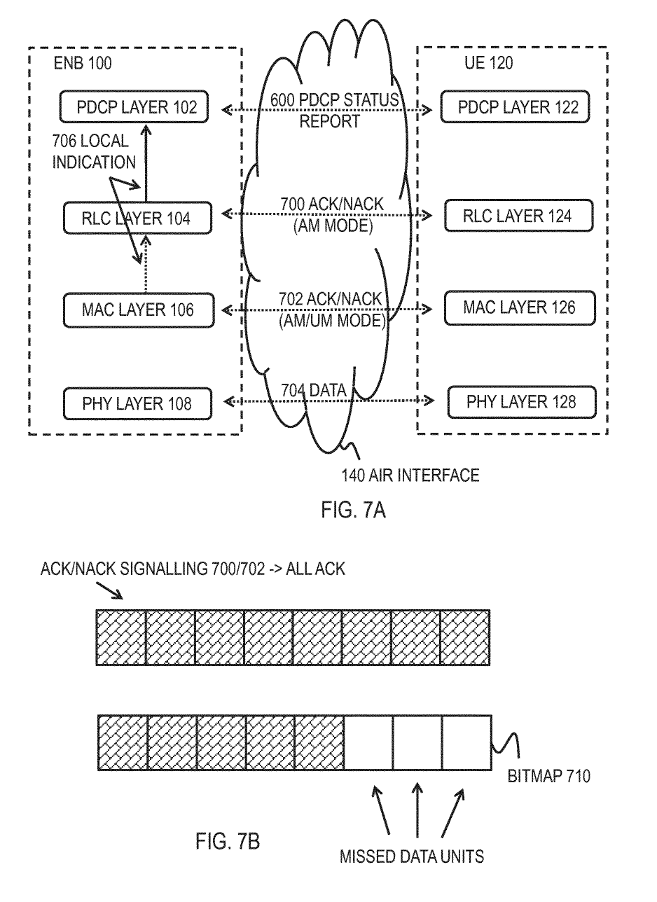

An embodiment of FIG. 7A shows some example signalling between different layers of the eNB 100 and the UE 120. For example, the PDCP layers 102 and 122 may exchange PDCP status reports 600. The PDCP status report 600 may be transmitted e.g. when the RLC layer 124 is re-established (and its memory is cleared), such as at a handover. In such case, the PDCP status report 600 may handle the transition period. The RLC layers 104, 124 may exchange RLC level ACK/NACK signalling 700 between each other, at least for the case of the RLC AM mode. The MAC layers 106, 126 may transmit MAC level ACK/NACKs 702, e.g. in the case of the RLC AM and/or UM mode, for example. The actual transmission of data 704 and the ACK/NACKs 700, 702 and the PDCP status report 600 may take place by the physical layer 108, 128.

As shown in FIG. 7B, the eNB 100 may obtain a first indication about which of the transmitted data units the UE 120 has successfully received on a specific (first) protocol layer. In an embodiment, the specific protocol layer is one of MAC and RLC layers. The first indication may thus be a local indication 706 based on acknowledgements (ACK) information from one of the MAC and the RLC layers 104, 106 of the network node 100. For example, the ACK/NACK signalling 700/702 may indicate which data units the lower layers 124, 126 of the UE 120 have received correctly and which not. The RLC or MAC layer 104, 106 of the eNB 100, receiving the ACK/NACK signalling 700/702, may then provide the first indication to the higher PDCP layer 102 of the eNB 100. Let us assume here that the UE 120 has successfully received all the transmitted data units. This is shown in FIG. 7B with blocks having diagonal bricks. That is, the UE 120 may have transmitted an ACK for each of the received data units in question. This may mean that the MAC layer 126 of the UE 120 has received all the data units mapped to the RLC UM successfully or that the RLC layer 124 of the UE 120 has received all the data units mapped to the RLC AM successfully.

In an embodiment, the UE 120 indicates those data units (such as PDCP SDUs) for which the overflow counter value de-sync has been observed (i.e. for which the overflow counter value has been detected to be different) as not received data units in the PDCP status report 600. In an embodiment, this means that those bits of the “bitmap”-field 710 of FIG. 7B of the status report 600 which according to sequence numbers correspond to the missed data units may be set to indicate a failed reception. For example, a bit “0” may indicate unsuccessfully received data unit at the PDCP layer 122 of the UE 120. In an embodiment, the FMS-field of the PDCP status report 600 may also indicate the unsuccessful deciphering of at least one received data unit.

Thus, based on the received PDCP status report 600, the eNB 100 obtains a second indication about which data units the UE120 has successfully received on another (second) protocol layer. In an embodiment, this other protocol layer is the PDCP layer. Let us here assume that at least one of the transmitted data units has not been successfully received by the UE 120. For example, as shown in FIG. 7B, the “bitmap”-field of the PDCP status report 600 may indicate non-successful data unit reception at least for some data units (e.g. the thee last data units). This unsuccessful reception at the PDCP layer 122 may be due to incapability to correctly decipher the data correctly although the MAC layer 126 or the RLC layer 124 may have received the data correctly from the eNB 100.

Thus, the indications of the ACK/NACK signalling 700/702 and the PDCP status report 600 may provide contradictory indications regarding the successful reception of the data units. Based on this, the eNB 100 may determine that the UE 120 is applying a different HFN 210B than the HFN 210A used by the eNB 100. That is, the errors at the UE's 100 end are only encountered at the higher layers during deciphering/decompression of data. The radio propagation channel itself may be good and the lower layers (PHY, MAC, RLC layers) may have received the data correctly.

In an embodiment, the status report (such as the PDCP status report 600) may be applied in indicating the different overflow counter value (e.g. the HFN 210) only for data units transferred according to the RLC AM. This may be beneficial at least in order to keep backward compatibility of the proposal to legacy UEs. However, in one embodiment, the proposed method as depicted in FIGS. 3 and 4 is applied also to data units transferred according to the RLC UM.

Owing to the proposed manner of informing the DL HFN de-sync to the network, the UL data may not be rendered unusable but the UE 120 is able to report the DL HFN de-sync to the eNB 100 while ensuring UL data intact. Further, no necessary changes in any signalling formats (such as in the PDCP status report 600) are needed. Thus, the proposal may be implemented by a legacy-release UE. The eNB 100, depending on its protocol version, will either understand the meaning of the received unsolicited status report, or not, in which case it will discard it.

Let us take a look at one example manner of generation the PDCP status report 600. According to the proposal, when the UE 120 has detected a HFN de-synchronization in the downlink, the PDCP layer 122 of the UE 120 may, if the radio bearer is configured by upper layers to send the PDCP status report in the uplink to the eNB 100, compile the PDCP status report after processing the PDCP PDUs that are 2 5 received from lower layers 124, 126, 128, and submit the PDCP status report 600 to the lower layers 124, 126, 128 as the first PDCP PDU for transmission. The compiling of the PDCP status report 600 may comprise 1) setting the FMS field to the PDCP SN of the first missing PDCP SDU; 2) if there is at least one out-of-sequence PDCP SDU stored, allocating a “bitmap”-field of length in bits equal to the number of PDCP SNs from and not including the first missing PDCP SDU up to and including the last out-of-sequence PDCP SDUs, rounded up to the next multiple of 8; 3) setting as ‘0’ in the corresponding position in the “bitmap”-field for all PDCP SDUs that have not been received as indicated by the lower layers 124, 126, 128 or have been received with incorrectly assumed HFN 210B, and optionally PDCP SDUs for which decompression have failed; and 4) indicating in the “bitmap”-field as ‘1’ for all other PDCP SDUs.

Naturally, the indications of ‘0’ and ‘1’ may be switched.

Although described by using the PDCP layer, the layer responsible of the overflow mechanism and of the overflow counter value re-synchronization may be some other layer of the protocol stack as well. This depends on the implementation of the system. The proposal is thus applicable on another layer of the protocol stack as well.

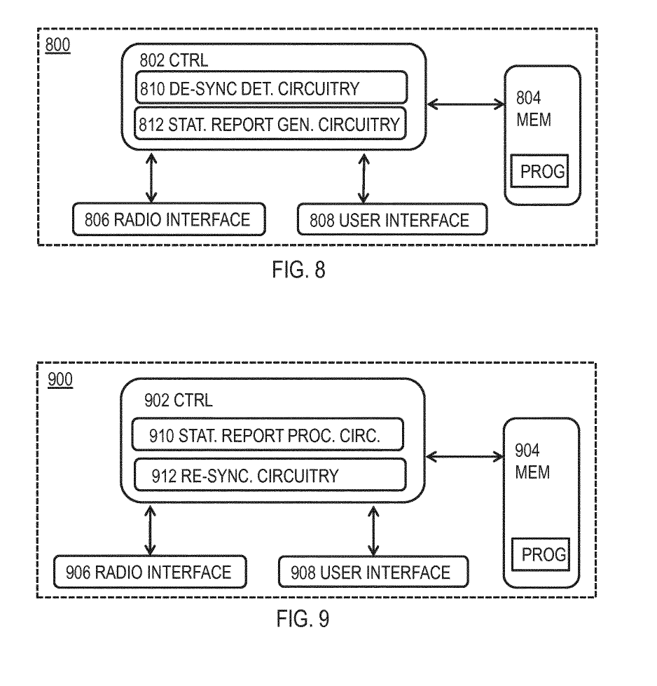

FIGS. 8 to 9 provide apparatuses 800, 900, each comprising a control circuitry (CTRL) 802, 902 such as at least one processor, and at least one memory 804, 904 including a computer program code (PROG), wherein the at least one memory and the computer program code (PROG), are configured, with the at least one processor, to cause the respective apparatus to carry out any one of the embodiments described. The memory 804, 904 may be implemented using any suitable data storage technology, such as semiconductor based memory devices, flash memory, magnetic memory devices and systems, optical memory devices and systems, fixed memory and removable memory.

The apparatuses 800, 900 may further comprise communication interfaces (TRX) 806, 906 comprising hardware and/or software for realizing communication connectivity according to one or more communication protocols. The TRX may provide the apparatus with communication capabilities to access the radio network, for example.

The apparatuses 800, 900 may also comprise user interfaces 808, 908 comprising, for example, at least one keypad, a microphone, a touch display, a display, a speaker, etc. Each user interface may be used to control the respective apparatus by the user.

In an embodiment, the apparatus 800 may comprise the terminal device of a cellular communication system, e.g. a user equipment (UE), a user terminal (UT), a computer (PC), a laptop, a tabloid computer, a cellular phone, a mobile phone, a communicator, a smart phone, a palm computer, or any other communication apparatus.

Alternatively, the apparatus 800 is comprised in such a terminal device. Further, the apparatus 800 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 800 may be, comprise or be comprised in a mobile phone, such as the UE 120, operating according to the long term evolution or the long term evolution advanced, or the 5G.

The control circuitry 802 may comprise a de-synchronization detection circuitry 810 for detecting the de-sync of the overflow counter value, such as the HFN 210. The detection may take place due to incapability to correctly decipher received PDCP SDUs, for example. A status report generation circuitry 812 may be for generating, on the basis of the detection of the de-sync, the status report, such as the PDCP status report 812, and for causing a transmission of the status report to the transmitter of the received data.

In an embodiment, the apparatus 900 may be or be comprised in a base station (also called a base transceiver station, a Node B, a radio network controller, or an evolved Node B, for example). In an embodiment, the apparatus 900 is or is comprised in the network node 100. In an embodiment, the network node 100 may operate according to the long term evolution, the long term evolution advanced, or the 5G.

The control circuitry 902 may comprise a status report processing circuitry 910 for reception and processing of the status report, such as of the PDCP status report 600. The circuitry 910 may, e.g. be configured to detect the DL HFN de-sync in case the status report is received unsolicited and/or if the received status report contains contradictory information when compared to indications from other layers of the protocol stack. A re-synchronization circuitry 912 may be for triggering and controlling the re-synchronization of the overflow counter value, such as the HFN 210. This circuitry 912 may be responsible, e.g. for triggering RRC connection re-establishment in order to re-initialize the HFNs 210A, 210B to a common value.

In an embodiment at least some of the functionalities of the apparatus 900 of FIG. 9 may be shared between two physically separate devices forming one operational entity. Therefore, the apparatus 900 may be seen to depict the operational entity comprising one or more physically separate devices for executing at least some of the described processes. The apparatus 900 utilizing such shared architecture, may comprise a remote control unit (RCU), such as a host computer or a server computer, operatively coupled (e.g. via a wireless or wired network) to a remote radio head (RRH) located in the base station. In an embodiment, at least some of the described processes may be performed by the RCU. In an embodiment, the execution of at least some of the described processes may be shared among the RRH and the RCU.

In an embodiment, the RCU may generate a virtual network through which the RCU communicates with the RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1 to 9 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 9 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-25. (canceled)

26. A method, comprising:
detecting, by a user device, that an overflow counter value applied by the user device in reception of data transmission from a network node is different than the overflow counter value applied by the network node to the data transmission; and
transmitting a data packet reception-status report to the network node to inform the network node about the detection.

27. The method of claim 26, wherein the reception-status report is transmitted despite not being configured to send such status report due to other events.

28. The method of claim 26, further comprising:
indicating those data units for which the overflow counter value de-synchronization has been observed as not received data units in the reception-status report.

29. The method of claim 26, further comprising:
applying the reception-status report in indicating the different overflow counter value only for data units transferred according to a radio link control acknowledgement mode, RLC AM.

30. The method of claim 26, further comprising:
indicating, in the status report, a desired way for the network node to perform a network-triggered synchronization of the overflow counter value.

31. The method of claim 26, wherein the overflow counter value is a hyper frame number, HFN.

32. The method of claim 26, wherein the reception-status report is a packet data convergence protocol, PDCP, status report.

33. An apparatus, comprising:
at least one processor and at least one memory including a computer program code, wherein the at least one memory and the computer program code are configured, with the at least one processor, to cause a
user device to perform operations comprising:
detecting that an overflow counter value applied by the user device in reception of data transmission from a network node is different than the overflow counter value applied by the network node to the data transmission; and
deciding to transmit a data packet reception-status report to the network node to inform the network node about the detection.

34. The apparatus of claim 33, wherein the reception-status report is transmitted despite not being configured to send such status report due to other events.

35. The apparatus of claim 33, wherein the at least one memory and the computer program code are configured, with the at least one processor, to cause the user device further to perform operations comprising:
indicating those data units for which the overflow counter value de-synchronization has been observed as not received data units in the reception-status report.

36. The apparatus of claim 33, wherein the at least one memory and the computer program code are configured, with the at least one processor, to cause the user device further to perform operations comprising:
applying the reception-status report in indicating the different overflow counter value only for data units transferred according to a radio link control acknowledgement mode, RLC AM.

37. The apparatus of claim 33, wherein the at least one memory and the computer program code are configured, with the at least one processor, to cause the user device further to perform operations comprising:
indicating, in the status report, a desired way for the network node to perform a network-triggered synchronization of the overflow counter value.

38. The apparatus of claim 33, wherein the overflow counter value is a hyper frame number, HFN.

39. The apparatus of claims 33, wherein the reception-status report is a packet data convergence protocol, PDCP, status report.

40. An apparatus, comprising:
at least one processor and at least one memory including a computer program code, wherein the at least one memory and the computer program code are configured, with the at least one processor, to cause a network node to perform operations comprising:
causing a reception of a data packet reception-status report from a user device;
determining, based on the reception-status report, that an overflow counter value applied by the user device in reception of data transmission from the network node is different than the overflow counter value applied by the network node to the data transmission; and
deciding to perform a synchronization of the overflow counter values applied by the user device and by the network node.

41. The apparatus of claim 40, wherein the at least one memory and the computer program code are configured, with the at least one processor, to cause the network node further to perform operations comprising:
considering the reception of the reception-status report, in the absence of any other event calling for the reception-status report, as an indication that the user device is applying a different overflow counter value.

42. The apparatus of claim 40, wherein the at least one memory and the computer program code are configured, with the at least one processor, to cause the network node further to perform operations comprising:
obtaining a first indication about which data units the user device has successfully received on a specific protocol layer;
obtaining, based on the received reception-status report, a second indication about which data units the user device has successfully received on another protocol layer, wherein the first and second indications provide contradictory information; and
determining, based on the contradictory indications, that the user device is applying a different overflow counter value.

43. The apparatus of claim 42, wherein the specific protocol layer is one of a medium access control, MAC, layer and a radio link control, RLC, layer, and the other protocol layer is a packet data convergence protocol, PDCP, layer.

44. The apparatus of claim 40, wherein the overflow counter value is a hyper frame number, HFN.

45. The apparatus of claim 40, wherein the reception-status report is a packet data convergence protocol, PDCP, status report.
